(19) United States
(12) Patent Application Publication
(10) Pub. No.: US 2026/0359743 A1
(43) Pub. Date: Nov. 12, 2026

(54) METHOD AND SYSTEM FOR MANAGING WORK ORDERS

(71) Applicant: Accenture Global Solutions Limited, Dublin (IE)

(72) Inventors: Selvakuberan KARUPPASAMY, Chennai (IN); Milind Pandurang KHARAT, Navi Mumbai (IN); Sunil Kumar BM, Bangalore (IN); Vinu VARGHESE, Bangalore (IN); Tamashri Ghosh DEB, Bangalore (IN); Litha DHANANJAYAN, Bangalore (IN); Sreenivas Sekhar JOSYULA, Bangalore (IN); Sreevidya PRASAD, Bangalore (IN); Ritesh Prakash DUBAL, Mumbai (IN); Sougata Kumar DAS, Bangalore (IN)

(73) Assignee: Accenture Global Solutions Limited, Dublin (IE)

(21) Appl. No.: 19/202,629

(22) Filed: May 8, 2025

(51) Int. Cl. G06Q 10/0631

(52) U.S. Cl. CPC G06Q 10/063112; G06Q 10/06316

(57) ABSTRACT

Method, system, and computer-readable storage media for managing work orders are disclosed. Key terms are identified from conversation history of a conversation originated by a potential user. The key terms identify issues to be resolved. A search is performed in a knowledge base storing historical work orders that are associated with the issues to be resolved and previously performed tasks are identified for each historical work order. The identified previously performed tasks are optimized to create tasks and technicians are identified by identifying previous technicians who performed tasks for each historical order, a performance rating of each previous technician, and factors. Based on the created tasks and the technicians, a work order is created for resolving the issues and the work order is executed to determine a subset of technicians from the technicians. The subset of technicians is presented as available technicians for resolving the issues.

### TECHNICAL FIELD

Various examples described herein relate generally to method, system, and computer program product for managing work orders.

### BACKGROUND

In general, enterprises provide field services in support of managing assets (e.g., products or physical devices) deployed in fields of their users or customers. The field services may include a range of tasks such as delivery, installation, repair, and/or replacement of the assets or at least some parts of the assets, performing analysis on performance and maintenance of the assets, and/or the like. The enterprises may allocate appropriate resources (e.g., technicians, operators, and/or the like) for performing the tasks of the field services by diagnosing issues with the assets, determining the appropriate resources based on the diagnosed issues, and coordinating schedules of the appropriate resources. However, diagnosing the issues, determining the appropriate resources and coordinating the schedules of the resources may be challenging.

### SUMMARY

In at least one example, the present disclosure provides a computer-implemented method for managing work orders. The method includes receiving conversation history of a conversation originated by a potential user. From the conversation history, the method includes identifying a plurality of key terms. The plurality of key terms identifies one or more issues to be resolved. The method includes performing a search in a knowledge base storing historical work orders that are associated with the one or more issues to be resolved. The method includes identifying a plurality of previously performed tasks for each historical work order of the historical work orders found in the search and creating tasks for resolving the one or more issues by optimizing one or more previously performed tasks of the plurality of previously performed tasks. The method includes identifying a plurality of technicians for resolving the one or more issues by identifying a plurality of previous technicians who performed tasks for each of the historical work orders, a performance rating of each previous technician of the plurality of previous technicians with regard to each of the historical work orders, and a plurality of factors. Based on the created tasks and the identified plurality of technicians, the method includes generating a work order for resolving the one or more issues. The method includes executing the work order to determine a subset of the plurality of technicians for resolving the one or more issues and presenting the subset of the plurality of technicians as available technicians to resolve the one or more issues.

The present disclosure further describes a system for implementing the method provided herein. The present disclosure also describes a non-transitory computer-readable storage media (CRM) having instructions stored thereon which, when executed by one or more processors of a computing device, cause the computing device to perform operations in accordance with the method described herein.

It is appreciated that the method in accordance with the present disclosure can include any combination of the aspects and features described herein. That is, the method in accordance with the present disclosure is not limited to the combinations of aspects and features specifically described herein but also includes any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

Various examples in accordance with the present disclosure will be described with reference to the drawings, in which:

FIG. 1 depicts an example environment used to execute implementations of the present disclosure.

FIG. 2 depicts an example conceptual architecture of a work order manager of a system disclosed in the example environment of FIG. 1, for managing work orders, in accordance with implementations of the present disclosure.

FIG. 3 depicts an example conceptual architecture of a work order generation and management engine of the work order manager, for generating and managing a work order, in accordance with implementations of the present disclosure.

FIG. 4 depicts an example hyperactive graph and agent-based framework, in accordance with implementations of the present disclosure.

FIG. 5 depicts an example illustration of a hyperactive graph, in accordance with implementations of the present disclosure.

FIG. 6 depicts an example process flow of recommending time slots and associated optimized probabilities for a work order, in accordance with implementations of the present disclosure.

FIG. 7 is a flow diagram that presents an example computer implemented method for managing the work orders, in accordance with implementations of the present disclosure.

FIG. 8 depicts an example computer system to implement the system disclosed in the example environment of FIG. 1, in accordance with implementations of the present disclosure.

Like reference numbers and designations in the various drawings indicate like elements.

### DETAILED DESCRIPTION

In the following description, various examples will be illustrated by way of example and not by way of limitation in the figures of the accompanying drawings. References to various examples in this disclosure are not necessarily to the same example, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Reference to any “example” herein (e.g., “for example,” “an example of,” by way of example,” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various examples given in this specification.

Without intent to limit the scope of the disclosure, examples of instruments, apparatus, methods, and their related results according to the examples of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

The term “comprising” when utilized means “including, but not necessarily limited to”; it specifically indicates open-ended inclusion or membership in the so-described combination, group, series, and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality or acts involved.

Specific details are provided in the following description to provide a thorough understanding of examples. However, it will be understood by one of ordinary skill in the art that examples may be practiced without these specific details. For example, systems may be shown in block diagrams so as not to obscure the examples in unnecessary detail. In other instances, well-known processes, structures, and techniques may be shown without unnecessary detail in order to avoid obscuring example examples.

The specification and drawings are to be regarded in an illustrative rather than a restrictive sense. It will, however, be evident that various modifications and changes may be made thereunto without departing from the broader spirit and scope as set forth in the claims.

An enterprise may receive work requests for assets being deployed in fields or locations of its users. The work requests may identify or outline issues to be resolved. The issues may be associated with the assets and may include hardware malfunctions, physical damage or breakdown, security vulnerabilities, and/or the like. The enterprise may employ an existing field service management (FSM) system for processing the work requests.

For processing a work request, the existing FSM system may create tasks (e.g., field service tasks) corresponding to the issues outlined in the work requests. The tasks may include ordering, installation, repairing, and/or replacement of the assets, performing analysis on performance of the assets, performing maintenance of the assets, and/or the like. The tasks may be created by analyzing issues outlined in the work request, and determining and adjusting skills required for resolving the issues. Upon creating the tasks, the existing FSM system may allocate resources (e.g., technicians, operators, and/or the like) for performing the tasks. The resources may be allocated for performing the tasks by grouping a set of resources based on base locations of the assets and skills required for resolving the issues outlined in the work requests. However, the existing FSM system may employ manual processes (e.g., employ multiple human agents) for creating the tasks and allocating the resources for the tasks. Such manual processes may pose limitations for the existing FSM system if there is an increase in volumes of the work requests and if the work requests include complex issues.

For example, creation of the tasks using the manual processes may lead to inefficiencies, increased risk of errors (e.g., incorrect task assignments, miscommunications, overlooking necessary work steps required to perform the tasks), and increased delays, which may hamper quality of the tasks by affecting productivity of the enterprise. Further, due to the manual processes, the existing FSM system may fail to employ a standardized approach for creating the tasks that may result in inconsistencies in descriptions, priorities, and/or the like, of the tasks. Due to lack of the standardized approach, creation of the tasks may vary from one manual agent to another that may pose limitations for the existing FSM system to track progress or maintain quality across the tasks. Therefore, creation of the tasks using the existing FSM system may be labor-intensive, error-prone, and time-consuming and the created tasks may include inaccurate or unclear or incomplete descriptions of the tasks. Such a creation of the tasks may create ambiguities and inefficiencies in scheduling of the tasks and further result in misaligned priorities, improper allocation of the resources, and delays in resolution of the issues. The delays in resolution of the issues may reduce efficiency and quality of processing the work requests, which may lead to user dissatisfaction and may reduce engagement of the users with the enterprise that may lead to potential loss of work requests from the users in future.

Further, for allocating the resources to the tasks, the existing FSM system may fail to consider other factors (e.g., details of the determined resources, a current workload associated with each of the resources, and/or the like) that may affect allocation of the resources for the tasks and availability of components (parts or materials or elements of the assets) required for performing the tasks. For example, even though a resource allocated for a task is having necessary skills, the resource may not always be suitable for the respective task due to an experience level, historical turnaround time taken by the resource for issue resolution, unavailability of the components with the resource, and/or the like. Therefore, creating the tasks and allocating the resources for the tasks without ensuring the appropriate or suitable resource along with the availability of the required components at the right time and at a right location may incur follow-up or additional tasks, and increase time, cost, and utilization of computing resources.

In addition, the existing FSM system may fail to dynamically adjust the tasks and allocation of the resources by adapting to changes in availability of the resources, the required components, and/or the like, which may result in increased costs, suboptimal resource allocation, and inflexible dispatching of the resources.

Implementations of the present disclosure are directed to efficient and effective generation and management of work orders by enabling accurate, error-free, and timely creation of tasks along with efficient allocation of resources for the tasks. The tasks may be created by identifying key terms (from a conversation between a user and a system) describing issues associated with an asset and building a contextual task creation engine to create the tasks by integrating and correlating the key terms with historical work orders that include similar issues identified with the asset. The resources may be allocated for the tasks by performing real-time data integration and historical data analysis using agents indicated by a hyperactive graph for the tasks. The real-time data integration and historical data analysis may include integrating and correlating data of the resources (e.g., real-time location data of the resources, performance data of the resources, and/or the like) with the historical work orders to determine a subset of resources for the tasks. Further, each resource in the subset of resources may be ranked and recommended with a time slot for performing the respective tasks. In addition, part requirements (e.g., requirement of parts or materials or components of the assets) may be predicted based on the tasks, skills of the resources, and locations associated with the assets and accordingly part requests may be integrated with inventory management. The part requests may provide a notification for maintaining availability of the parts of the assets at any time for satisfying demands for such parts of the assets.

Implementations of the present disclosure may further enable a scenario-based simulation and adaptive dispatching approach for dynamically updating allocation of the resources for the tasks. For example, “what-if” scenarios (e.g., traffic, weather, unavailability of the resources, new urgent tasks, and/or the like) may be evaluated to recommend or automatically execute updating of the allocation of the resources based on predefined priorities and/or enterprise rules.

Implementations of the present disclosure may build a knowledge base that integrates the historical work orders in a centralized manner. The historical work orders from the knowledge base may be recommended for creating the tasks and allocating resources for the tasks corresponding to new work orders. In addition, the historical work orders may be used as a source of learning. For example, the resources may be trained to how to successfully resolve the issues outlined in new work orders based on the historical work orders stored in the knowledge base.

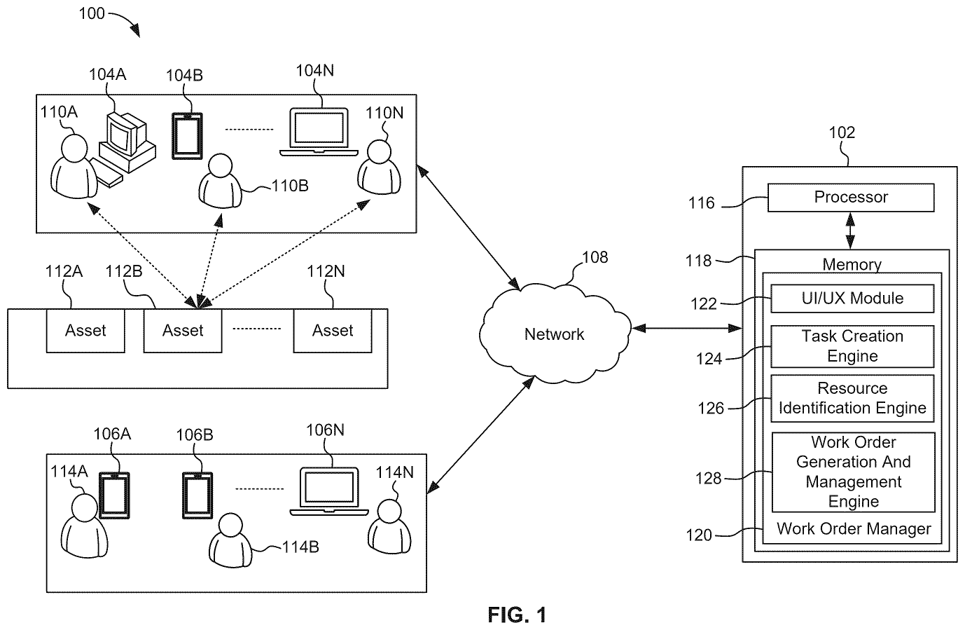

FIG. 1 depicts an example environment 100 used to execute implementations of the present disclosure. The example environment 100 may enable efficient and effective generation and management of work orders.

The example environment 100, depicted in FIG. 1, includes a system 102, user devices 104A-104N, and computing devices 106A-106N. The system 102 (e.g., also be referenced as a computing device, a Field Service Management (FSM) system, and/or the like) may be employed by an enterprise for generating and managing the work orders. The system 102 may communicate with the user devices 104A-104N and the computing devices 106A-106N using a network 108. In some examples, the network 108 may include a Local Area Network (LAN), a Wide Area Network (WAN), the Internet, or a combination thereof. In some examples, the network may be accessed over a wired and/or a wireless communication link.

The user devices 104A-104N may be associated with users 110A-110N, respectively. The users 110A-110N may include potential customers or clients of the enterprise, an external enterprise or organization, and/or the like. Non-limiting examples of a user device may include a server, a notebook, a desktop, a netbook, smartphones, laptops, a tablet, and/or voice-enabled devices. It is contemplated that implementations of the present disclosure may be realized with any appropriate type of user devices.

The user devices 104A-104N may be used by the users 110A-110N, respectively, to provide work requests to the system 102 for processing. The work requests may be associated with assets 112A-112N. In some examples, the assets 112A-112N may be deployed in fields or work sites or locations of the users 110A-110N, respectively. By way of non-limiting example, the assets 112A-112N may include physical devices or physical equipment, vehicles, medical devices, machinery, tools, robotic devices, laptops, servers, printers, communication devices, home appliances, electronic items, electric lifts, surveillance systems, Heating, Ventilation, and Air Conditioning (HVAC) systems, Internet of Things (IoT) devices, or any other similar tangible and physical products that require maintenance, repairs, installations, and/or the like. In some other examples, the assets 112A-112N may include service-oriented products such as shipments, warranty management, license or configurations related to applications, and/or the like. Therefore, the work requests may be associated with various domains or sectors such as retail industries, medical, telecommunication, Information Technology (IT), manufacturing and utilities, automotive, and/or the like.

The work requests may be provided to the system 102 for resolving issues identified with the assets 112A-112N through repair, maintenance, installation, and/or the like. In some examples, a work request associated with an asset of the assets 112A-112N may include descriptions of one or more issues associated with the asset, a location or field associated with the asset, optionally details of the asset (e.g., a model number, a unique identifier, a license, configurations, a year of purchase, manufacturing or servicing details, and/or the like, of the asset), and/or the like. In some examples, the issues identified with the assets 112A-112N may include physical damage or breakdown of the assets 112A-112N, malfunctions of the assets 112A-112N or part of the assets 112A-112N, security vulnerabilities, and/or the like.

In some examples, the user devices 104A-104N may execute one or more applications, which may allow the users 110A-110N to provide the work requests to the system 102. Non-limiting examples of the one or more applications may include messaging applications, chatbot applications, voice call or video call applications, emailing applications, e-commerce applications, social media applications, or any other suitable applications. The one or more applications may allow the users 110A-110N to initiate conversations with an operator of the system 102, so that the work requests may be provided through the initiated conversations. While implementations of the present disclosure are described by considering the work requests provided to the system 102 through the conversations such as messaging conversations, video or voice call conversations, and/or the like, it is contemplated that implementations of the present disclosed may also be realized by considering the work requests provided to the system 102 through images, text files, emails, fax notes, forms, and/or the like.

The computing devices 106A-106N may be used by resources 114A-114N, respectively. Non-limiting examples of a computing device may include a server, a notebook, a desktop, a netbook, smartphones, laptops, a tablet, and/or voice-enabled devices. It is contemplated that implementations of the present disclosure may be realized with any appropriate type of computing devices. In some examples, the resources 114A-114N may include technicians, operators of the assets 112A-112N, customer agents, and/or the like. Hereinafter, for simplicity, the resources 114A-114N may be referenced as technicians 114A-114N throughout the document. The computing devices 106A-106N may be used by technicians 114A-114N to register with the system 102. The technicians 114A-114N may register with the system 102 by providing information that include, for example, skills of the technicians, a past experience of resolving the issues identified with the assets, available time slots, and/or the like.

The system 102 may generate and manage the work orders by allocating some of technicians, from the technicians 114A-114N, for resolving the issues outlined in the work requests. In some examples, the system 102 may be implemented as an on-premises system that is operated by the enterprise or a third-party engaged in cross-platform interactions and work orders management. In some examples, the system 102 may be implemented as an off-premises system (for example, cloud or on-demand) that is operated by the enterprise or a third-party on behalf of the enterprise. In some examples, the system 102 may be implemented in a cloud environment. For simplicity, the system 102 depicted in FIG. 1 may be a cloud-based system that is intended to represent various forms of servers including a web server, an application server, a proxy server, a network server, a server pool, and/or the like.

In some examples, the system 102 may be implemented by way of a single device or a combination of multiple devices that may be operatively connected or networked together. The system 102 may be implemented in hardware or a suitable combination of hardware and software. The “hardware” may include a combination of discrete components, an integrated circuit, an application-specific integrated circuit, a field-programmable gate array, a digital signal processor, or other suitable hardware. The “software” may include one or more objects, agents, threads, lines of code, subroutines, separate software applications, or other suitable software structures operating in one or more software applications.

The system 102 includes a processor 116 and a memory 118 communicably coupled to the processor 116. The processor 116 may include one or more processors. Examples of the processor 116 may include, but are not limited to, microprocessors, microcomputers, microcontrollers, digital signal processors, central processing units, state machines, logic circuits, and/or any devices that manipulate data or signals based on operational instructions. Among other capabilities, the processor 116 may fetch instructions (also be referenced to as processor-executable instructions or machine-executable instructions) from the memory 118 and execute the fetched instructions for performing operations according to the present disclosure. The memory 118 may be non-volatile or non-transitory computer-readable medium (CRM) such as, a magnetic disk or solid-state non-volatile memory or volatile medium such as Random Access Memory (RAM), and/or the like.

Further, the system 102 includes a work order manager 120. The work order manager 120 may be stored in the memory 118 and provided as a downloadable library including the instructions. The work order manager 120 may include modules 122-128 such as a User Interface (UI)/User Experience (UX) (UI/UX) module 122, a task creation engine 124, a resource identification engine 126, and a work order generation and management engine 128.

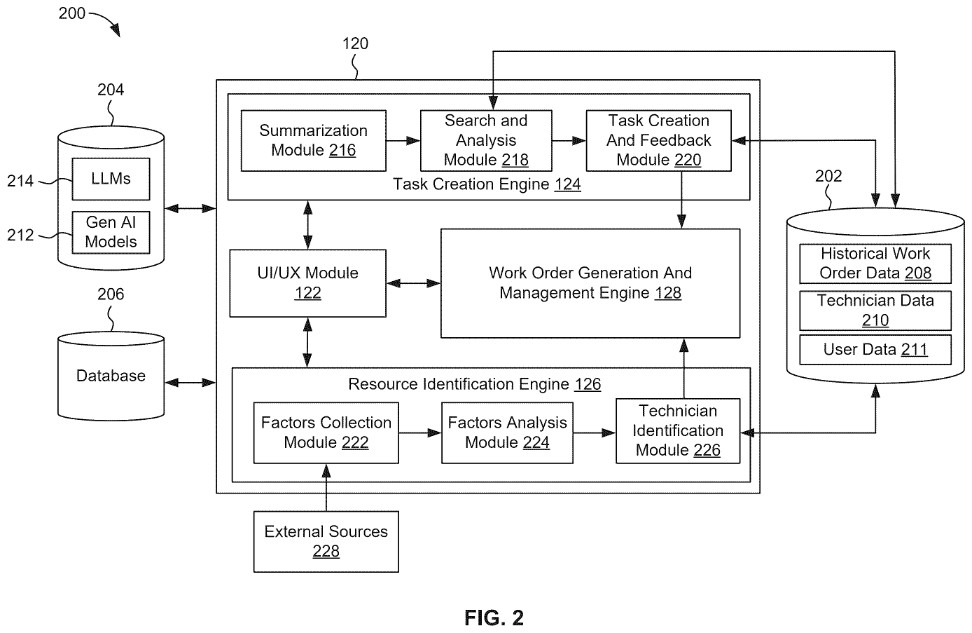

In an implementation, the processor 116 may execute the modules 122-128 of the work order manager 120 for receiving the work requests from the user devices 104A-104N through the conversations initiated with the system 102 and generating and managing the work orders for resolving the issues of the assets outlined in the work requests. Generation of the work orders may include creation of tasks (also be referenced as field services, field service tasks, and/or the like) for resolving the issues identified with the assets and identification of a set of technicians, from the technicians 114A-114N (e.g., registered technicians) for the tasks. Managing the work orders may include executing the work orders that result in allocation of a subset of technicians, from the set of technicians, for resolving the issues with the assets, procurement of materials required for resolving the issues identified with the assets, receiving user feedback on resolving the issues by the subset of technicians, and/or the like. Various examples depicting generation and management of the work orders are described in detail in conjunction with FIGS. 2-8.

FIG. 2 depicts an example conceptual architecture 200 of the work order manager 120 of the system 102 disclosed in the example environment 100 of FIG. 1, for managing the work orders, in accordance with implementations of the present disclosure. The work order manager 120, depicted in FIG. 2, may be communicatively coupled to a knowledge base 202, a model database 204, and a database 206.

The knowledge base 202 may be created by monitoring and tracking conduction or execution of the work orders over a time. The knowledge base 202 includes historical work order data 208, technician data 210, and user data 211. The historical work order data 208 may include historical work orders, results of conduction or execution of the historical work orders, previous time slots at which the historical work orders have been conducted or executed, and/or the like. The historical work orders may include work orders that have been generated and executed for previous work requests. The historical work orders may indicate previous issues identified for resolving and previous tasks created for resolving the previous issues. The results of conducting or executing the historical work orders may identify one or more of: previously performed tasks for resolving the previous issues, previous technicians, from the technicians 114A-114N (depicted in FIG. 1), assigned for the previously performed tasks, previous procurement of parts or materials of the assets for resolving the previous issues, and user feedback received upon resolving the previous issues.

The technician data 210 may include registration data, work history, performance data, and/or the like, of the technicians 114A-114N registered with the system 102. The registration data of a technician may include information of the technician such as a current location or a geographical area of the technician, working hours of the technician, self-nominated slots of the technician, skills and proficiency of the technician, and/or the like. The work history of the technician may indicate a behavior of the technician towards the historical work orders, for example, an acceptance trend identifying a number of acceptances of the historical work orders by the technician, a cancellation trend identifying a number of cancellation or rejections of the historical work orders by the technician, a no show trend identifying a number of times the technician has not provided responses for the work orders, and/or the like. The performance data of the technician may indicate a performance rating of the technician with respect to each of the historical work orders and current workload of the technician.

The user data 211 may include information of the users 110A-110N (depicted in FIG. 1), who requested the system 102 for processing the work requests, over a time. Information of a user may include one or more of: a location area or a geographical area of the user, working hours of the user, past history identifying reporting of any sensitive issues by the user, and/or the like.

Additionally, or alternatively, the knowledge base 202 may also include location wise events and holiday calendars and enterprise policies (not shown in FIG. 2). The location wise event and holiday calendars may identify upcoming events or holidays in the respective locations deployed with the assets 112A-112N. The enterprise policies may provide rules or flags for processing the work requests. In some examples, the knowledge base 202 may be dynamically updated by the work order manager 120 after processing of each work order.

The model database 204 may include Generative Artificial Intelligence (Gen AI) models 212 and Large Language Models (LLMs) 214. The Gen AI models 212 and the LLMs 214 may be used by the various modules 122-128 of the work order manager 120 via an Application Programming Interface (API) for generating and managing the work orders. Non-limiting examples of the Gen AI models 212 may include foundation models or LLMs, Machine Learning (ML) models, Artificial Intelligence (AI) models, and/or the like. Non-limiting examples of the LLMs 214 may include Generative Pre-trained Transformer 3.5 (GPT 3.5), GPT 4, Mosaic's Pretrained Transformer (MPT), Llama models, and/or the like. In some examples, the Gen AI models 212 and the LLMs 214 may include open-source models, fine-tuned models, proprietary models, and/or the like. The open-source models may include models that have been trained based on a diverse range of datasets. The fine-tuned models may include models that have been trained based on a specific set of datasets, so that the models may be used for generating and managing the work orders related to a specific domain/industry. For example, the fine-tuned models may include the models that have been trained based on datasets related to an automotive industry, so that the models may be used for generating and managing work orders specifically for the automotive industry. The proprietary models may include models that have been trained based on a specific set of datasets, which are tailored to the enterprise.

The database 206 may store various data and intermediate results generated by the UI/UX module 122, the task creation engine 124, the resource identification engine 126, and the work order generation and management engine 128 of the work order manager 120.

The UI/UX module 122 may represent one or more interfaces of the one or more applications (e.g., chatbot applications, voice or video applications, messaging applications, and/or the like) that may be executed on a user device of the user devices 104A-104N (depicted in FIG. 1) to initiate or originate a conversation between a respective user of the user device and an operator (e.g., a call center Point of Contact (POC), a virtual agent, an Interactive Voice Response (IVR) system, and/or the like) of the system 102. The conversation may include multiple dialogs exchanged between the user and the operator of the system 102. The multiple dialogs may be referenced as a conversation history of the conversation. The conversation history may identify a work request describing one or more issues to be resolved. The one or more issues may be associated with an asset of the assets 112A-112N. The conversation history of the conversation originated by the user may be provided to the task creation engine 124, the resource identification engine 126, and the work order generation and management engine 128.

The task creation engine 124 may create tasks for the work request received through the conversation. The task creation engine 124 includes a summarization module 216, a search and analysis module 218, and a task creation and feedback module 220.

The summarization module 216 may summarize the conversation history to identify key terms. The key terms may indicate the one or more issues associated with the asset of the assets 112A-112N. Additionally, or alternatively, the key terms may indicate a location or work site associated with the asset and user requested self-slots. The user requested self-slots may indicate time slots for resolving the one or more issues. In some examples, the summarization module 216 may use one of the Gen AI models 212 to identify the key terms from the conversation history. The identified key terms may be provided to the search and analysis module 218.

The search and analysis module 218 may perform a search on the knowledge base 202 to identify similar one or more historical work orders from the historical work order data 208. The similar one or more historical work orders may include historical work orders including the one or more issues identified from the key terms of the conversation history. In some examples, the search and analysis module 218 may use one of the LLMs 214 for identifying the similar one or more historical work orders. The identified similar one or more historical work orders may be provided to the task creation and feedback module 220.

The task creation and feedback module 220 may create the tasks for resolving the one or more issues identified from the key terms of the conversation history. For creating the tasks, the task creation and feedback module 220 may identify previously performed tasks for each of the similar one or more historical work orders by analyzing the historical work order data 208 using one of the LLMs 214. Non-limiting examples of the previously performed tasks may include routine maintenance of the asset, fixing a critical power outage for the asset, and/or the like. Based on the identified previously performed tasks, the task creation and feedback module 220 may create the tasks. The tasks may be created by optimizing the previously performed tasks using one of the Gen AI models 212. In some examples, optimizing the previously performed tasks may include removing duplicate tasks, identifying relativity of the previously performed tasks for the one or more issues identified from the key terms of the conversation history, and/or the like. Non-limiting examples of the tasks may include routine maintenance of the asset, fixing a power outage for the asset, installing a new smart meter, replacing a few parts of the asset, rerouting shipments, and/or the like. As would be understood, the tasks may vary based on the asset and the one or more issues identified with the asset. By way of non-limiting example, the tasks identified for serving an elevator system of an office may include initial diagnosis, spare parts procurement, system upgrade installation, testing and calibration, user feedback and optimization, and/or the like. The tasks created for resolving the one or more issues may be provided to the work order generation and management engine 128. The tasks may also be stored in the database 206.

Additionally, or alternatively, the task creation and feedback module 220 may also generate feedback for the previously performed tasks. The task creation and feedback module 220 may analyze the historical work order data 208 using one of the Gen AI models 212 and identify previous technicians who were assigned for the previously performed tasks. Further, the task creation and feedback module 220 may receive user feedback from the users of the user devices associated with the previously performed tasks. The task creation and feedback module 220 may analyze the user feedback to determine whether each technician has resolved the previous issues in accordance with criteria suggested by the user. In some examples, the criteria suggested by the user may include a time slot suggested to resolve the previous issues, a time duration suggested for resolving the previous issues, a specific manner in which the tasks to be performed for resolving the previous issues, a requirement for Service Level Agreement (SLA) adherence, and/or the like. Based on results of determining whether each technician has resolved the previous issues in accordance with the criteria suggested by the user, the task creation and feedback module 220 may generate the performance rating for each of the previous technicians. Based on the performance rating of each of the previous technicians, the task creation and feedback module 220 may further assign the rank for each of the previous technicians. The feedback may be used to update the technician data 210 in the knowledge base 202 using one of the LLMs 214.

The resource identification engine 126 may identify a set of technicians, from the technicians 114A-114N, for resolving the one or more issues associated with the asset. The resource identification engine 126 includes a factors collection module 222, a factors analysis module 224, and a technician identification module 226.

The factors collection module 222 may collect factors (e.g., also be referenced as external data, environmental factors, and/or the like) from external sources 228, based on the location or work site associated with the asset for which the one or more issues to be resolved. Non-limiting examples of the external sources 228 may include local news websites, weather applications, traffic applications, a location application or location tracker, and/or the like. In some other examples, the factors collection module 222 may collect the factors from the location wise events and holiday calendars stored in the knowledge base 202. Additionally, or alternatively, the factors may also be updated by the user via the respective user device. Non-limiting examples of the factors may include traffic conditions around the location associated with the asset, weather conditions of the location associated with the asset, information about events (e.g., festivals, rallies, road shows, campaigns, and/or the like) being occurring around the location associated with the asset, and/or the like. The factors may be provided to the factors analysis module 224 and the technician identification module 226.

The factors analysis module 224 may estimate cost of travel and an estimated time of arrival (ETA) for each of the technicians 114A-114N to reach the location associated with the asset. In some examples, the factors analysis module 224 may apply Linear programming on the factors to estimate the cost of travel and the ETA. The cost of travel and the ETA estimated for each of the technicians 114A-114N may be provided to the technician identification module 226.

The technician identification module 226 may identify the set of technicians, from the technicians 114A-114N, for resolving the one or more issues associated with the asset. The technician identification module 226 integrate and correlate the factors, and the cost of travel and the ETA estimated for each of the technicians 114A-114N (e.g., indicating real-time data) with the historical work order data 208 and the technician data 210 (accessed from the knowledge base 202) using one of the Gen AI models 212 to identify the set of technicians for resolving the one or more issues identified with the asset. The identified set of technicians may be provided to the work order generation and management engine 128. Additionally, or alternatively, the identified set of technicians in the database 206.

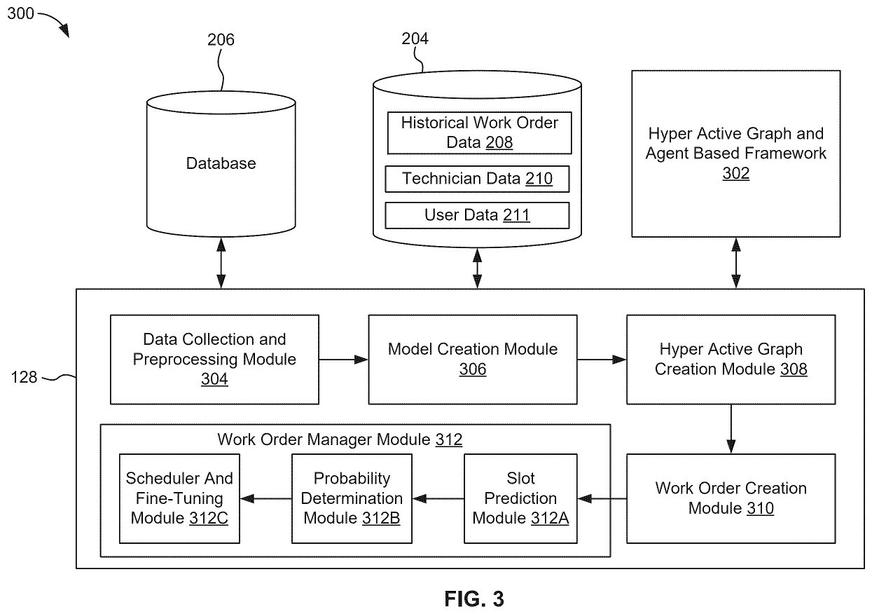

The work order generation and management engine 128 may generate and manage the work order for resolving the one or more issues identified with the asset. Generation and managing of the work order using the work order generation and management engine 128 is described in detail in conjunction with FIGS. 3-6.

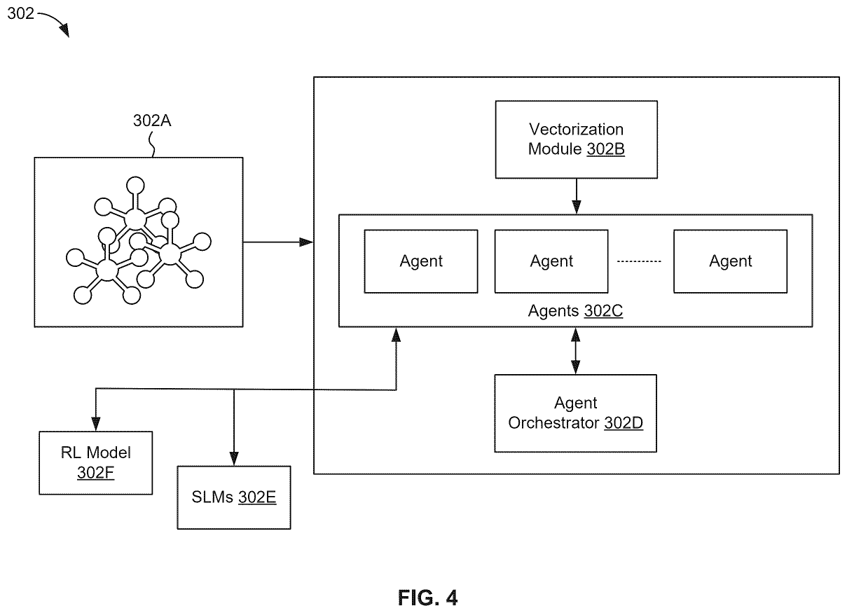

FIG. 3 depicts an example conceptual architecture 300 of the work order generation and management engine 128 of the work order manager 120, for generating and managing the work order, in accordance with implementations of the present disclosure. The work order generation and management engine 128 may use a hyperactive graph and agent-based framework 302 for generating and managing the work order. The hyperactive graph and agent-based framework 302 is depicted in detail in conjunction with FIG. 4.

As depicted in FIG. 4, the hyperactive graph and agent-based framework 302 includes hyperactive graphs 302A, a vectorization module 302B, agents 302C, and an agent orchestrator 302D (also be referenced as agent +orchestrator, central agent, and/or the like).

The hyperactive graphs 302A may be created based on the historical work order data 208, and the technician data 210 of the technicians 114A-114N (depicted in FIG. 1) stored in the knowledge base 202. The hyperactive graphs 302A include virtual and dynamic structures that are created for connecting the agents 302C to specific subtasks of the tasks. Therefore, the hyperactive graphs 302A may facilitate collaboration and decision-making across a network of the agents 302C, which aid in efficient generation and management of the work order. The vectorization module 302B may convert the hyperactive graphs into respective vector representations for further processing using the agents 302C.

The agents 302C may include Small Language Model (SLM) based agents. Each of the agents 302C or the SLM based agents may access SLM of SLMs 302E for performing intended functions. Non-limiting examples of the SLMs 302E may include MiniLM, DistilBERT, T5-Small, and/or the like. Each of the agents 302C may have a memory (not shown in FIG. 3) and unique prompts, roles, and attributes. The memory of each of the agents 302C may store interactions or information exchanged by the respective agent with other agents. The roles of each of the agents 302C may indicate functions which are being performed by the respective agent. The attributes of each of the agents 302C may indicate attributes or input data to be provided for performing the intended functions.

By way of non-limiting example, the agents 302C may include technician agents, task agents, material agents, environmental agents, a supervisor agent, technician and user agents, and/or the like. The technician agents may have a role in allocating a specific technician for a specific task. The technician agents may have the attributes such as skills of the set of technicians identified for resolving the tasks, the location of the asset, workload of each of the set of technicians, and the performance data of the set of technicians. The task agents may have a role to prioritize the tasks. The task agents may have the attributes such as urgency associated with resolving of the one or more issues, the skills required for resolving the one or more issues, a time duration estimated for resolving the one or more issues, and/or the like, to prioritize the tasks. The material agents may have a role in procuring spare materials (e.g., components, materials, parts, and/or the like, of the asset) for resolving the one or more issues. The material agents may have the attributes such as availability of the materials, transportation plans for procurement of the spare materials, and inventory optimization. The environmental agents may have a role in adjusting the cost of travel and the ETA for each of the set of technicians based on real-time updates that may include traffic updates, weather updates, local disruptions, and/or the like. The supervisor agent may have a role to supervise and coordinate other agents such as the technician agents, the task agents, the material agents, the environmental agents, and the technician and user agents, thereby optimizing objectives of the enterprise such as cost minimization, Service Level Agreement (SLA) adherence, user satisfaction, and/or the like. The technician and user agents may have a role to gather user feedback on resolving the one or more issues identified with the asset.

The agent orchestrator 302D may dynamically control or manage all the agents 302C and provide tools and configurations for each of the agents 302C to collaborate with each other. In an implementation, the agents 302C may be coupled with a Reinforcement Learning (RL) model 302F. The RL model 302F may provide rewards to the agents 302C.

Referring back to FIG. 3, the work order generation and management engine 128 includes a data collection and preprocessing module 304, a model creation module 306, a hyperactive graph creation module 308, a work order creation module 310, and a work order manager module 312. One or more of the components 304-314 of the work order generation and management engine 128 may use the hyperactive graph and agent-based framework 302 for generating and managing the work order.

The data collection and preprocessing module 304 may collect input data. In some examples, the data collection and preprocessing module 304 may collect the input data from the UI/UX module 122, the task creation engine 124, the resource identification engine 126, and the knowledge base 202. In some other examples, the data collection and preprocessing module 304 may collect the input data from the database 206. The input data may include the key terms identified from the conversation history, the created tasks and identified set of technicians for resolving the one or more issues associated with the asset, the historical work order data 208, the technician data 210, the user data 211, the factors, the cost of travel and the ETA. The key terms may indicate the one or more issues to be resolved for the asset, the location or work site of the asset, the time slots preferred by the user for resolving of the one or more issues, and/or the like. The historical work order data 208, the technician data 210, the user data 211, the factors, the cost of travel and the ETA for each of the set of technicians are described in detail in conjunction with FIG. 2, therefore repeated description is omitted herein for sake of brevity.

The data collection and preprocessing module 304 may preprocess the collected input data. Preprocessing the collected input data may include removing inappropriate or unnecessary or duplicate data from the input data, removing null values from the input data, filling missing values in the input data, removing outliers (e.g., variability or abnormality in some of data compared to other in the input data) from the input data, and/or the like.

After preprocessing the input data, the data collection and preprocessing module 304 may create a vector representation. For creating the vector representation, the data collection and preprocessing module 304 may identify the set of technicians allocated for resolving the one or more issues and identify skills of each technician in the set of technicians from the technician data. The data collection and preprocessing module 304 may create the vector representation out of the identified skills of each technician. The vector representation may refer to a numerical representation or embedding of the skills of each technician. The vector representation may be provided to the model creation module 306.

The model creation module 306 may create the RL model 302F (depicted in FIG. 4). The RL model 302F may be used to provide the rewards for the agents 302C (depicted in FIG. 4) of the hyperactive graph and agent-based framework 302, which is described in detail along with the work order manager module 312. The RL model 302F may be created by summarizing the skills of all the technicians in the set of technicians identified for resolving the one or more issues and identifying the time slots requested by the user for resolving the one or more issues. In some examples, the RL model 302F may include one of a value-based RL model, a policy-based RL model, an actor-critic based RL model, a multi-agent RL model, and/or the like.

The hyperactive graph creation module 308 may create a hyperactive graph for resolving the one or more issues associated with the asset. For generating the hyperactive graph, the hyperactive graph creation module 308 may identify the tasks created for resolving the one or more issues from the preprocessed data, and the skills required for performing the created tasks from task data stored in the knowledge base 202 (not shown in FIG. 3). The task data may indicate association of the skills with each of the predefined tasks. The hyperactive graph creation module 308 may also capture information about the agents 302C from the hyperactive graph and agent-based framework 302. The information of the agents 302C may indicate the roles and the attributes of the agents 302C. The hyperactive graph creation module 308 may correlate the identified tasks and the associated required skills with the roles and the attributes of the agents 302C. Based on the correlation of the identified tasks with the roles and the attributes of the agents 302C and the hyperactive graphs 302A of the hyperactive graph and agent based framework 302, the hyperactive graph creation module 308 may select a set of agents, from the agents 302C, for the tasks. Further, the hyperactive graph creation module 308 may create the hyperactive graph by connecting the set of agents for the tasks. One or more agents from the set of agents may be connected to each task.

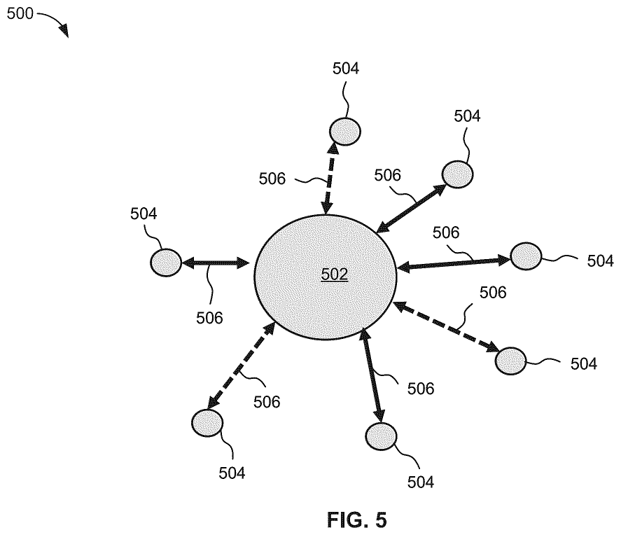

An example illustration 500 depicting the hyperactive graph is depicted in FIG. 5. As depicted in FIG. 5, the hyperactive graph includes a center node 502, nodes 504 connected to the center node 502, and edges 506 between the nodes 504 and the center node 502. The nodes 504 may indicate the set of agents identified for the tasks from the agents 302C. The center node 502 may indicate the agent orchestrator 302D assigned for controlling the set of agents represented by the nodes 504. The edges 506 between the nodes 504 and the center node 502 may represent the tasks. Further, the edges 506 between the nodes 504 and the center node 502 may indicate a status (e.g., active or inactive) of the respective agents associated with the nodes 504. For example, as depicted in FIG. 5, among the edges 506, edges with straight lines may indicate the agents that are active or available for the respective tasks and edges with dotted lines may indicate the agents that are inactive or unavailable for the respective tasks.

In an example scenario, consider that a work request identifies routine maintenance of a HVAC system. In such a scenario, the hyperactive graph may connect the agents such as the technician agents, the material agents, and the environmental agents for performing tasks like selecting and allocating an appropriate technician with relevant skills for performing the maintenance of the HVAC system, ensuring availability of the materials required for performing the maintenance of the HVAC system, and adjusting an ETA of the technician based on real-time traffic conditions, respectively.

In another example scenario, consider that a work request identifies fixing of a critical power outage. In such a scenario, the hyperactive graph may connect the agents such as the technician agents, the task agents, and the supervisor agent for performing tasks like selecting and allocating an appropriate technician with relevant skills for fixing the power outage, prioritizing the work request, and ensuring rapid allocation of the materials required for fixing the power outage, respectively.

In yet another example scenario, consider that a work request identifies installation of a new smart meter. In such a scenario, the hyperactive graph may connect the agents such as the technician agents, the technician and user agents, and the material agents for scheduling installation of the new smart meter based on availability of the user and workload of the set of technicians identified for the work request.

In yet another example scenario, consider that a work request identifies issue in a shipment. In such a scenario, for supply chain disruption management, the hyperactive graph may connect the agents such as the material agents and the environmental agents for identifying alternative routes for rerouting the shipment due to unexpected delays and materials (e.g., transportation or vehicles) required to minimize disruptions.

Referring back to FIG. 3, once the hyperactive graph is created, the work order creation module 310 may generate the work order. The work order may be created using the hyperactive graph and the preprocessed input data. For generating the work order, the work order creation module 310 may create subtasks for each of the tasks based on the skills required for each of the tasks, identify the set of agents connected to each of the tasks using the hyperactive graph, and assign an agent for each of the subtasks of each of the tasks from the set of agents respectively connected to each of the tasks. The subtasks of a task may indicate required work steps to accomplish the respective task. The work order may include the subtasks of each of the tasks to be performed for resolving the one or more issues, the skills required for each of the subtasks, the set of agents for performing the subtasks of each of the tasks, and/or the like.

By way of non-limiting example, consider a scenario where the input data indicates (i) one or more issues (e.g., frequent breakdowns, improper leveling, slow response times during peak hours, and/or the like) to be resolved for an asset like an elevator system of an office building; (ii) tasks created for resolving the issues, wherein the tasks include initial diagnosis, spare parts procurement, system upgrade installation, testing and calibration, user feedback and optimization, and/or the like; (iii) the set of technicians identified for the tasks; (vi) the factors, the cost of travel, and the ETA identified for each of the set of technicians: and (v) the location of the asset. In such a scenario, the hyperactive graph creation module 308 may create a hyperactive graph for the elevator system by connecting the set of agents from the agents 302C to the tasks. As a non-limiting example, (i) the technician agents and the environmental agents may be connected to the initial diagnosis; (ii) the material agents and the supervisor agent may be connected to the spare parts procurement; (iii) the technician agents and task agents may be connected to the system upgrade installation; (vi) the technician agents and the environmental agents may be connected to the testing and calibration; and (v) the technician and user agents and the supervisor agent may be connected to the user feedback and optimization. The hyperactive graph may be provided to the work order creation module 310.

The work order creation module 310 may generate a work order for resolving the one or more issues with the elevator system by creating the subtasks for each of the tasks and assigning each agent in the set of agents to perform one of the subtasks, for example,

Initial Diagnosis: The work order creation module 310 may create subtasks for the initial diagnosis to identify root causes of the one or more issues such as breakdowns, improper leveling, and slow response times across multiple components of the elevator system. By way of non-limiting examples, a first subtask and a second subtask may be created for the initial diagnosis. The first subtask may include performing detailed description of the elevator system including its components such as control panels, motor, cables, and safety mechanisms. The second subtask may include performing external factor evaluation. Among the technicians agents and the environmental agents connected to the initial diagnosis, the work order creation module 310 may assign the technician agents for the first subtask and the environmental agents for the second subtask. The technician agents may be used to select and allocate a subset of technicians from the set of technicians for performing the first subtask that is for inspecting the components of the elevator system and diagnosing the issues associated with the components of the elevator system. The environmental agents may be used for performing the second subtask that is for performing the external factor evaluation like evaluating or monitoring power fluctuations or weather conditions affecting performance of the elevator system.

### Spare Parts Recruitment:

First Subtask: Identify and source required materials (e.g., spare parts).
Second Subtask: Managing delivery schedules of the required materials. The first and second subtasks may ensure availability of the components or materials of the elevator system such as control systems, motors, and cables within a tight timeline to avoid delays.
Material Agents—First Subtask: The material agents may check inventory, schedule orders for procurement of the required materials, and manage logistics.
Supervisor Agent—Second Subtask: The supervisor agent may supervise procurement timelines and prevent any associated bottlenecks.

### System Upgrade Installation:

First Subtask: Replace control systems, motors, cables, and recalibrate leveling mechanisms.
Second Subtask: Ensure proper sequencing and SLA compliance.
Technician Agents—First Subtask: The technician agents may select and allocate the subset of technicians, from the set of technicians, for performing physical installations and recalibrations.
Task Agents—Second Subtask: Coordinating the first subtask to ensure proper sequencing and SLA compliance. Therefore, physical replacement of outdated components in the elevator system may be performed with minimized downtime.

### Testing and Calibration:

First Subtask: Conduct test runs to validate performance, safety, and compliance.
Second Subtask: External factor simulation.
Technician Agents—First Subtask: The technician agents may select and allocate the subset of technicians, from the set of technicians, for performing individual and system-level tests on the elevator system.
Environmental Agents—Second Subtask: The environmental agents may be used to simulate the external factors such as peak usage or peak load and power disruptions. Therefore, by performing the first and second subtasks, it may be ensured that all the components of the elevator system function seamlessly under various weather conditions such as peak load or power outages.

### User Feedback and Optimization:

First Subtask: Collect user feedback from the users (e.g., occupants) of the office building, fine-tuning performance of the agents assigned for the above-described tasks, and resolve remaining any issues.
Second Subtask: Implement optimizations
Technician and User Agents—First Subtask: The technician and user agents may be used to gather the user feedback, identify updates and/or any concerns from the gathered user feedback, and generating plans to address the identified concerns.
Supervisor Agent—Second Subtask: The supervisor agent may be used to implement optimizations to meet goals and SLAs associated with the office building management.

The generated work order may be provided to the work order manager module 312. The work order manager module 312 may manage the work order by predicting the appropriate time slots for the work order and scheduling execution of the work order based on the predicted appropriate time slots. In some examples, the work order manager module 312 may include a slot prediction module 312A, a probability determination module 312B, and scheduler and fine-tuning module 312C.

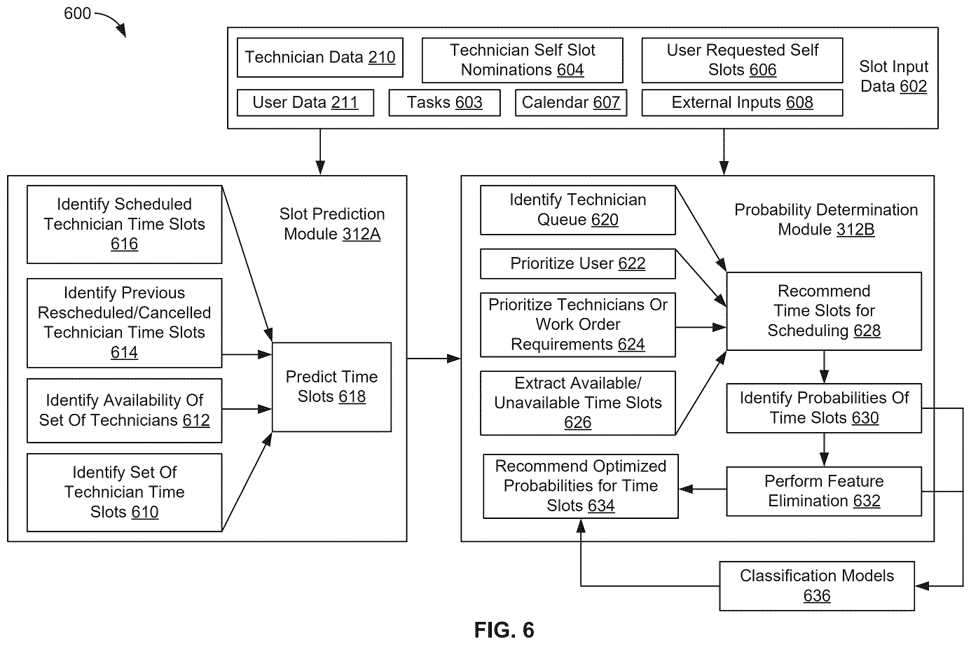

The slot prediction module 312A may predict time slots for the work order. Predicting the time slots for the work order may refer to predicting the time slots for performing the subtasks of each of the tasks in the work order. The probability determination module 312B may recommend time slots and associated optimized probabilities based on the predicted time slots. An example process flow 600 of recommending the time slots for the work order and the associated optimized probabilities is depicted in detail in FIG. 6.

As depicted in FIG. 6, the slot prediction module 312A may receive slot input data 602. The slot input data may include the technician data 210 associated with the set of technicians identified for resolving the one or more issues, the user data 211, the tasks, for example, tasks 603, created for resolving the one or more issues identified with the asset, technician self-slot nominations 604, user requested self-slots 606, and external inputs 608. The technician data 210 for the set of technicians identified for resolving the one or more issues and the user data 211 may be received from the knowledge base 202. The tasks 603 may be received from the database 206 or the task creation engine 124. The technician self-slot nominations 604 may be received from the set of computing devices (of the computing devices 106A-106N) associated with the set of technicians (from the technicians 114A-114N) identified for resolving the one or more issues. The technician self-slot nominations 604 may include a set of time slots selected by the set of technicians for resolving the one or more issues identified with the asset. Hereinafter, the set of time slots selected by the set of technicians may be referenced as a set of technician time slots. The user requested self-slots 606 may be received from the user device associated with the user who provided the work request for resolving the one or more issues associated with the asset. The user requested self-slots 606 may include a set of time slots selected by the user. Hereinafter, the set of time slots selected by the user may be referenced as a set of user time slots. The external inputs 608 may include time slot inputs (indicating time slots) selected by one or more external entities associated with the asset, for example, a supervisor of the location or the work site where the asset is being deployed, a location or work site owner, and/or the like.

Upon receiving the slot input data 602, the slot prediction module 312A may identify 610 the set of technician time slots from the technician self-slot nominations 604. The technical self-slot nominations 604 may include a previous set of technician time slots selected by the set of technicians for resolving previous issues and a set of technician time slots selected for future. The slot prediction module 312A may identify 612 availability of the set of technicians from the calendar 607 associated with the set of technicians. The slot prediction module 312A may identify 614 previous rescheduled or cancelled technician time slots from the technician data 210. The previous rescheduled or cancelled technician time slots may indicate previous time slots that have been rescheduled or cancelled by the set of technicians while resolving the previous issues. The slot prediction module 312A may identify 616 scheduled technician time slots from the technician data 210. The scheduled technician time slots may include time slots that have scheduled for resolving the previous issues. Based on the set of technician time slots, the availability of the set of technicians, the previous rescheduled or cancelled technician time slots, and the scheduled technician time slots, the slot prediction module 312A may predict 618 the time slots for resolving the one or more issues associated with the asset. The predicted timeslots along with the slot input data 602 may be provided to the probability determination module 312B.

The probability determination module 312B may identify 620 a technician queue. For example, the technician queue may be identified based on the skills and the performance rating of the set of technicians identified from the technician data 210 associated with the set of technicians. The technician queue may indicate a sequential arrangement of the set of technicians for resolving the one or more issues identified with the asset.

The probability determination module 312B may prioritize 622 the user with respect to other users. The user and other users may belong to the users 110A-110N, who have raised the work requests. The user may be prioritized based on pre-defined priority configurations and/or the user data 211 and/or the user requested self-slots 606. The pre-defined priority configurations may indicate a priority level associated with each of the users 110A-110N based on their previous interactions with the system 102.

The probability determination module 312B may also prioritize 624 the set of technicians or work order requirements. Prioritizing the set of technicians may include assigning priority levels for the set of technicians based on the technician data 210 associated with the set of technicians. The work order requirements may indicate the skills required for performing the subtasks of the tasks, configurations or tools required by the agents for performing the respectively assigned subtasks, the location or the work site of the asset, and/or the like. Prioritizing the work order requirements may include prioritizing the skills required for performing the subtasks, prioritizing execution of the subtasks, and/or the like.

The probability determination module 312B may further extract 626 available (free) or unavailable (busy) time slots of the technicians from the calendar 607 of the set of technicians.

Based on the technician queue, the priority of the user, the prioritized set of technicians or the prioritized work order requirements, the available or unavailable time slots of the technicians, the probability determination module 312B, and the predicted time slots (by the slot prediction module 312A), the probability determination module 312B may recommend 628 time slots for execution of the work order. The recommended time slots may recommend the time slots for execution of each of the subtasks of each of the tasks in the work order.

After recommending the time slots, the probability determination module 312B may identify 630 probabilities for the recommended time slots. A probability identified for a time slot may indicate a likelihood or chance of execution or occurrence of the work order (e.g., a respective subtask in the work order) at the respective time slot. In some examples, the probabilities for the recommended time slots may be identified using one of the classification models 636 such as logistic regression models, random forest models, State Vector Machine (SVM) based models, Naïve Base Classifiers, and/or the like.

Once the probabilities are identified for the time slots, the probability determination module 312B may perform 632 feature elimination. The feature elimination may include performing recursive feature elimination with cross validation (RFECV) on the classification model used for identifying the probabilities for the recommend time slots. By performing the RFECV, the probability determination module 312B may identify appropriate features of the classification model to retain and inappropriate features of the classification model to filter out among a complete set of features of the classification model. The inappropriate features may be filtered out from the complete set of features of the classification model.

Further, the probability determination module 312B may recommend 634 optimized probabilities for the time slots. The optimized probabilities for the time slots may be recommended using the classification model with the identified appropriate features. The optimized probabilities may include an updated or fine-tuned version of the probabilities that have been determined using the complete set of features of the classification model.

Referring back to FIG. 3, the probability determination module 312B may provide the recommended time slots and the optimized probabilities for the recommended time slots to the scheduler and fine-tuning module 312C.

The scheduler and fine-tuning module 312C may identify the time slots at which the historical work orders have been conducted or executed from the historical work order data 208 of the knowledge base 202 and the time slots at which the respective historical work orders were conducted successfully. Further, the scheduler and fine-tuning module 312C may compute a match between the user requested self-slots 606 with the recommended time slots. Based on the time slots at which the respective historical work orders were conducted successfully, the match between the user requested self-slots and the recommended time slots, and the probabilities of the recommended time slots, the scheduler and fine-tuning module 312C may identify the appropriate time slots (e.g., a final time slots) for execution or conduction of the work order. The appropriate time slots may include time slots for execution of the subtasks in the work order.

In some examples, once the appropriate time slots are determined, the scheduler and fine-tuning module 312C may communicate the appropriate time slots determined for the work order to the user via the respective user device and to the set of technicians (identified for resolving the tasks) via the respective computing devices. In response to communicating the appropriate time slots, the scheduler and fine-tuning module 312C may receive confirmation or rejection of the appropriate time slots by the user and/or the set of technicians. In case of rejection of the appropriate time slots by the user, the scheduler and fine-tuning module 312C may determine new appropriate time slots by operating in conjunction with the slot prediction module 312A and the probability determination module 312B and by considering new user feedback as rejection of the appropriate time slots. Further, based on the confirmation or rejection of the appropriate time slots by each technician in the set of technicians, a number of work orders processed by each technicians, and a complexity of the work order, the scheduler and fine-tuning module 312C may generate a work order confirmation score for each technician in the set of technicians. Similarly, based on the confirmation or rejection of the appropriate time slots by the user, the scheduler and fine-tuning module 312C may generate a work order confirmation score for the user. The work order confirmation score may indicate an acceptance or cancellation trend. The scheduler and fine-tuning module 312C may update the technician data 210 associated with set of technicians and the user data 211 in the knowledge base 202 with the work order confirmation scores of the set of technicians and the user, respectively.

In accordance with the determined appropriate time slots and the work order confirmation score of each technician in the set of technicians, the scheduler and fine-tuning module 312C may execute the work order for resolving the one or more issues identified with the asset. To illustrate, the scheduler and fine-tuning module 312C may provide the work order, the preprocessed input data (described in detail above along with the data collection and preprocessing module 304), the determined appropriate time slots and the work order confirmation score of each technician in the set of technicians to the set of agents identified in the work order. The work order may indicate the subtasks of each of the tasks to be performed, the skills required for each of the subtasks, and the set of agents assigned for the subtasks. The preprocessed input data may include the technician data 210 associated with the set of technicians identified for resolving the one or more issues, the user data 211 associated with the user raised the work request for resolving the one or more issues, the factors obtained from the external sources, the enterprise policies, and/or the like. In some examples, the work order, the preprocessed input data, the determined appropriate time slots, and the work order confirmation score of each technician in the set of technicians may be converted into vector representations using the vectorization module 302B of the hyperactive graph and agent based framework 302. The vector representations of the work order, the preprocessed input data, the determined appropriate time slots, and the work order confirmation score of each technician may be provided to the set of agents.

Upon providing the work order, the preprocessed input data, and the appropriate time slots, and the work order confirmation score to the set of agents, the scheduler and fine-tuning module 312C may execute the set of agents for performing the respectively assigned subtasks by processing the preprocessed input data and in accordance with the determined respective time slots, thereby executing the work order. Execution of the agents or the work order may include selecting, assigning, and dispatching the subset of technicians, from the set of technicians, for resolving the one or more issues by performing the subtasks such as diagnosing or repairing or installing or testing the components of the asset at the identified respective final time slots, procurement of the materials required for resolving the one or more issues, supervising or monitoring conduction of the subtasks for resolving the one or more issues, collecting the user feedback from the user after conduction of the other subtasks, and/or the like.

By way of non-limiting example, execution of an agent like a technician agent (in the set of agents) may result in selection and allocation of the subset of technicians from the set of technicians for the respective subtasks, communicating a work order message to the subset of technicians for performing the respectively allocated subtasks via the respective computing devices, and enabling dispatching of the subset of technicians to the location or work site of the asset for resolving the one or more issues by performing the respectively allocated subtasks. In some examples, the selected and allocated subset of technicians for the respective subtasks may be presented on the user interface of the user device as available technicians for resolving the one or more issues. Therefore, the user may easily identify the subset of technicians allocated for resolving the one or more issues. Upon receiving approval or confirmation from the user regarding the available technicians, the agent may dispatch the subset of technicians for performing the respectively allocated subtasks. In an example, the agent may select and allocate a technician in the subset of technician for a specific subtask by analyzing the preprocessed input data (such as a current location or geographical area of the technician, working hours of the technician, an acceptance trend, a cancellation trend, a no-show trend, honoring acceptance trend, a list of current work orders, availability of the technician, past history of the technician identifying any serious or sensitive issues, an upcoming holiday, and/or the like), the determined appropriate time slots, and the work order confirmation score of each technician in the set of technicians and by estimating an optimized route to reach the location of the asset. The work order message sent for each technician in the subset of technicians may indicate the subtask to be performed, the time slot for performing the subtask, the location of the asset, and the optimized route to reach the location of the asset.

Additionally, or alternatively, execution of the agent like the technician agent may result in ranking of the subset of technicians, based on the technician's fitness to resolve the one or more issues according to the criteria (e.g., a requested time slot, a suggested time duration, a specific manner or way to perform each subtask, and/or the like) suggested by the user. The scheduler and fine-tuning module 312C may present results of execution of the work order (e.g., execution of the set of agents in the work order) on a user interface of the system 102 via the UI/UX module 122, so that the operator of the system 102 may track or monitor a progress of the work order.

In some examples, the scheduler and fine-tuning module 312C may execute the set of agents specified in the work order in a sequential manner and/or in a parallel manner, depending on the nature of each of the subtasks of the tasks.

With regards to the above-described example of resolving the issues associated with elevator system, the set of agents may be executed in the sequential manner for performing the subtasks of the tasks like the initial diagnosis, the system upgrade installation, and the user feedback and optimization, as such tasks have to follow a logical order since each task depends on a completion of a prior task. By way of non-limiting example, a first technician agent may be executed to allocate and dispatch a first technician in the subset of technician for the initial diagnosis before executing a second technician agent to allocate and dispatch a second technician in the subset of technician for the system upgrade installation. Once the system upgrade installation is completed, a technician and user agent may be executed to gather user feedback from the user. Based upon the gathered feedback, the supervisor agent may be executed to allocate a third technician in the subset of technician to optimize implementations (e.g., to fine-tune the performance of the asset) or to resolve any remaining issues identified with the asset.

The set of agents may be executed in a parallel manner for performing the subtasks of the tasks like the spare parts procurement and the testing and calibration. For example, while waiting for procurement of the spare parts of the elevator system the technician agent may be executed to allocate the subset of technicians for testing unaffected parts of the asset and preparation for installation in parallel. By way of non-limiting example, the subset of technicians may be assigned for testing different parameters of the elevator system such as load capacity, speed, and safety compliance, in parallel. Therefore, parallel execution of the set of agents may result in parallel conduction of some of the subtasks of the tasks, which may save time and improve efficiency of resolving the one or more issues identified with the asset.

Additionally, or alternatively, the scheduler and fine-tuning module 312C may perform fine-tuning of the SLMs 302E. For performing fine-tuning of the SLMs 302E, the scheduler and fine-tuning module 312C may provide the user feedback gathered or obtained upon conduction or execution of the subtasks to the RL model 302F. Based on the user feedback, the RL model 302F may assign the rewards for the set of agents involved in conduction of the subtasks. The rewards assigned for the set of agents may be used to fine-tune the associated SLMs 302E.

In some examples, the rewards may include positive rewards and negative rewards. The positive rewards may be assigned for the set of agents if the respectively assigned subtasks were successfully conducted or completed in accordance with the criteria suggested by the user (identified from the user feedback). The negative rewards may be assigned for the set of agents if the respectively assigned subtasks were not conducted or completed in accordance with the criteria suggested by the user (identified from the user feedback), or based on reception of misreports by the technicians about availability of the materials, or if the issues have been resolved by violating the policies of the enterprise, and/or the like. By way of non-limiting example, consider that the agent, like the task agent detects a critical HVAC repair request at a hospital (e.g., work request). In such a scenario, the technician agent may allocate a technician (e.g., skilled technician in nearby proximity to the hospital) to repair the HVAC system at the hospital. In case, if the allocated technician completes repairing of the HVAC system within SLA provided by the hospital (e.g., the criteria suggested by the user) despite traffic delays, the RL model 302F may assign the positive reward to the technician agent that aid in boosting technician's selection likelihood of the technician agent for future tasks, while reinforcing timeliness and skills of the technician. Alternatively, if the allocated technician misreports a spare part's availability for delaying repair of the HVAC system, the RL model 302F may assign the negative reward to the technician agent, which may enable the technician agent to reselect another technician for repairing the HVAC system by updating inventory predictions that may further prevent similar errors through continuous learning.

In an example, for fine-tuning a SLM of the SLMs 302E, the scheduler and fine-tuning module 312C may iteratively perform steps of: preparing and preprocessing a training dataset, defining a training process, retrain or fine-tune or train the SLM, performing optimization, and evaluating performance of the SLM model, until reaching a predefined iteration threshold or determining that the performance of the SLM model is optimized. Each iteration may be performed by incorporating new task-specific data.

In each iteration, the scheduler and fine-tuning module 312C may prepare the training dataset by including labelled dataset specific to the tasks. The scheduler and fine-tuning module 312C may preprocess the training dataset by removing inappropriate or unnecessary data from the training dataset, removing biased or sensitive data from the training datasets, standardizing or normalizing data in the training dataset associated with different formats, and/or the like. Upon preprocessing the training dataset, the scheduler and fine-tuning module 312C may define the training process. In an example, the training process may be defined with an appropriate loss function as well as indication for performing hyperparameter tuning. In accordance with the training dataset and the training process, the scheduler and fine-tuning module 312C may retrain or fine-tune or train the SLM to perform intended functions. Upon training or retraining or fine-tuning the SLM, the scheduler and fine-tuning module 312C may apply techniques like quantization to reduce a size of the SLM and improve performance of the SLM by reducing the loss function associated with an output of the SLM. Further, the scheduler and fine-tuning module 312C may evaluate the performance of the SLM by providing unexplored or new training datasets to the SLM and refine the training dataset based on performance metrics.

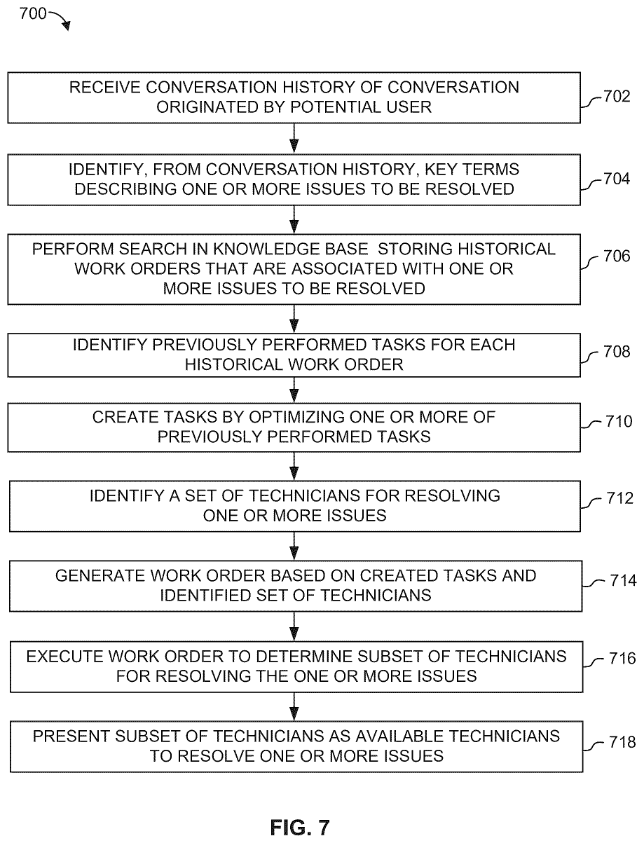

FIG. 7 is a flow diagram that presents an example computer implemented method 700 for managing the work orders, in accordance with implementations of the present disclosure. In some implementations, the method 700 may be executed by the processor 116 (including the one or more processors) of the system 102 using the various modules 122-128 of the work order manager 120, as described in relation to FIGS. 1-6.

The method 700 includes receiving 702 the conversation history of the conversation originated by the potential user. The conversation history may include the work request. The method 700 includes identifying 704, from the conversation history, the key terms describing the one or more issues to be resolved. The one or more issues may be associated with one of the assets 112A-112N depicted in FIG. 1. Identifying the key terms is described in detail along with the summarization module 216 of the task creation engine 124 in FIG. 2, therefore repeated description is omitted herein for sake of brevity.

Upon identifying the one or more issues, the method 700 includes performing 706 the search in the knowledge base 202 storing the historical work orders that are associated with the one or more issues to be resolved (e.g., the similar historical work orders). For each of the historical work orders found in the search, the method 700 includes identifying 708 previously performed tasks and creating 710 the tasks for resolving the one or more issues by optimizing one or more of the previously performed tasks. Creation of the tasks is described in detail along with the task creation engine 124 in FIG. 2, therefore repeated description is omitted herein for sake of brevity.

Further, the method 700 includes identifying 712 the set of technicians for resolving the one or more issues by identifying the previous technicians who performed tasks for each of the historical work orders, the performance rating of each previous technician with regard to each of the historical work orders, and the factors. The factors may include traffic conditions, weather conditions, cost of travel, and an estimated time when a technician from the technicians 114A-114N can become available for resolving the one or more issues. Identifying the set of technicians is described in detail along with the resource identification engine 126 in FIG. 2, therefore repeated description is omitted herein for sake of brevity.

Based on the created tasks and the identified plurality of technicians, the method 700 includes generating 714 the work order for resolving the one or more issues. Generating the work order is described in detail along with the work order creation module 310 of the work order generation and management engine 128 in FIGS. 3, 4, and 5, therefore repeated description is omitted herein for sake of brevity.

The method 700 includes executing 716 the work order to determine the subset of technicians for resolving the one or more issues. In some examples, the set of agents (e.g., the technician agents) from the agents 302C (depicted in FIG. 3) may be used for determining the subset of technicians. Each agent in the set of agents may be trained to identify the technician based on one or more of: a current location or geographical area of the technician, working hours of the technician, an acceptance trend, a cancellation trend, a no-show trend, honoring acceptance trend, a list of current work orders, availability of the technician, past history of the technician identifying any serious or sensitive issues, and/or an upcoming holiday. In some examples, the method 700 may include creating the RL model 302F for assigning the rewards to the agents 302C. The agents may include the SLM based agents, which are managed by the agent orchestrator 302D. Executing the work order is described in detail along with the work order manager module 312 of the work order generation and management engine 128 in FIGS. 3 and 6, therefore repeated description is omitted herein for sake of brevity.

In some examples, the method 700 may include generating the work order confirmation prediction score for each technician in the subset of technicians and ranking each technician in the subset of technicians based on the technician's fitness to resolve the one or more issues according to criteria suggested by the potential user (described in detail in conjunction with FIG. 3).

The method 700 includes presenting 718 the subset of the technicians as available technicians to resolve the one or more issues.

Implementations of the present disclosure provide technical solutions to multiple technical problems that arise in the context of managing work orders for resolving issues identified with assets. Implementations of the present disclosure enable generation and management of the work orders using a hyperactive graph and agent-based framework. A work order may be generated by identifying tasks to be performed for resolving one or more issues identified with an asset, identifying a set of technicians for resolving the tasks, and connecting agents for the tasks using hyperactive graphs. The tasks and the set of technicians may be identified based on skills required to perform the tasks, cost of travel and an ETA estimated for each technician based on real-time environmental factors, availability of required materials, workload of each technician, and/or the like. Further, the work order may be executed to select, allocate, and dispatch a subset of technicians, from the set of technicians, for resolving the one or more issues, ensure availability of materials recovered for resolving the one or more issues, gather user feedback upon resolving the one or more issues, and/or the like. The subset of technicians selected for resolving the issues using the agents may include available and skilled technicians located closest to the location of the asset for which the issues to be resolved.

In the present disclosure, the agents used for performing the tasks may include SLM based agents, which access SLMs for performing the respectively connected tasks. Usage of the SLM based agents may aid in generating and managing the work orders by improving computational efficiency, customization, interpretability, and scalability. For example, usage of the SLM based agents may require less computational power and less computing resources for performing the respectively connected tasks, thereby the work order may be generated and executed without any delays and with reduced cost and improved accuracy for real-time applications. Further, the SLMs may be fine-tuned without any complexity for specific domains or tasks, which may result in optimizing customizations. Furthermore, the SLM based agents may be easier to debug and analyze and may be optimal for distributed systems with limited computing resources, thereby interpretability and scalability of the work order may be enhanced.

Further, the hyperactive graphs used to connect the agents to the tasks may include virtual, dynamic structures designed to facilitate collaboration and decision-making across the agents, while achieving predefined goals of an enterprise efficiently. These graphs connect agents to specific tasks, resources, and environmental factors to achieve predefined goals efficiently. The hyperactive graphs may include features such as connectivity, adaptability, and reward-penalty based mechanisms. The connectivity may aid in seamlessly integrating the agents for real-time task allocation and optimization. The adaptability may aid in dynamically updating the connection of the agents with the tasks by monitoring updates in states and environmental changes of the agents. The reward-penalty based mechanisms may provide rewards or reinforcement signals to the agents based on their performance and adherence to goals. The rewards or reinforcement signals may be used to fine-tune the associated SLMs. For example, positive rewards may be provided to the agents for meeting SLAs, minimizing costs, and achieving high customer satisfaction, and negative rewards or penalties may be provided to the agents for delays, wastage of the materials, and non-compliance with objectives of the enterprise.

In addition, implementations of the present disclosure may execute agents (e.g., a supervisor agent) to monitor or track progress in real-time, compare actual performance associated with resolving the issues with the assets with expected timelines and milestones, and provide real-time recommendations for corrections or adjustments when tasks are deviating from an expected plan. Such feedback mechanisms employed using the agents may ensure that the tasks are performed in alignment with the best practices, while minimizing delays and improving service quality.

Therefore, with the above-described technical advantages, generation and management of the work orders according to the present disclosure may result in resolving the issues of the assets without any delays and errors, and with reduced cost, and utilization of the computing resources, which may further improve user satisfaction.

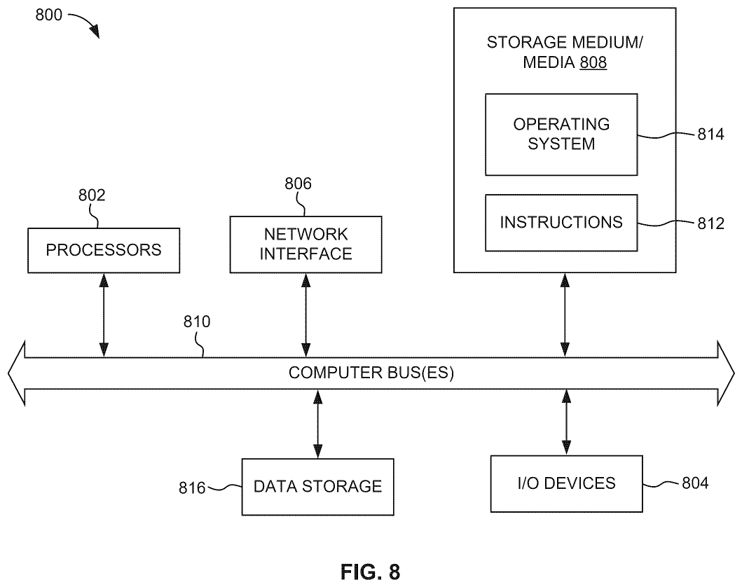

FIG. 8 depicts a computer system 800 that may be used to implement the system 102 disclosed in the example environment of FIG. 1. More particularly, computing machines such as desktops, laptops, smartphones, tablets, and wearables which may be used for managing the work orders. The computer system 800 may include additional components not shown and that some of the process components described may be removed and/or modified. In another example, a computer system 800 may be deployed on external-cloud platforms such as cloud, internal corporate cloud computing clusters, organizational computing resources, and/or the like.

The computer system 800 includes processor(s) 802 such as, a central processing unit, ASIC or another type of processing circuit, input/output devices (I/O devices) 804 such as, a display, mouse keyboard, etc., a network interface 806 such as, a Local Area Network (LAN), a wireless 802.11x LAN, a 3G or 4G mobile WAN or a WiMax WAN, and a storage media or medium 808 (also be referenced as computer-readable medium 808 (CRM)). Each of these components may be operatively coupled to a bus 810. The computer-readable medium 808 may be any suitable medium that participates in providing instructions to the processor(s) 802 for execution. For example, the computer-readable medium 808 may be non-transitory or non-volatile medium such as, a magnetic disk or solid-state non-volatile memory or volatile medium such as RAM. The instructions or modules stored on the computer-readable medium 808 may include machine-readable instructions 812 executed by the processor(s) 802 that cause the processor(s) 802 to perform the methods and functions of the system 102.

The system 102 may be implemented as software stored on a non-transitory processor-readable medium and executed by the processor(s) 802. For example, the computer-readable medium 808 may store an operating system 814 such as MAC OS, MS WINDOWS, UNIX, or LINUX, and code, for the system 102. The operating system 814 may be multi-user, multiprocessing, multitasking, multithreading, real-time, and the like. For example, during runtime, the operating system 814 is running and the code for the system 102 is executed by the processor(s) 802.

The computer system 800 may include a data storage 816, which may include non-volatile data storage. The data storage 816 stores any data used or generated by the system 102.

The network interface 806 connects the computer system 800 to internal systems for example, via a LAN. Also, the network interface 806 may connect the computer system 800 to the Internet. For example, the computer system 800 may connect to web browsers and other external applications and systems via the network interface 806.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer-readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random-access memory or both. Elements of a computer may include a processor for performing instructions and one or more memory devices for storing instructions and data. Generally, a computer also includes or is operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor(s) 802 and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and interact through a communication network. The relationship between client and server arises by virtue of computer programs running on the respective computers and having a client-server relationship with each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination with a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together into a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method for managing a work order, the computer-implemented method comprising:
receiving, by one or more processors of at least one computing device, conversation history of a conversation originated by a potential user;
identifying, by the one or more processors, from the conversation history, a plurality of key terms, wherein the plurality of key terms identify one or more issues to be resolved;
performing, by the one or more processors, a search in a knowledge base storing historical work orders that are associated with the one or more issues to be resolved;
identifying, by the one or more processors, a plurality of previously performed tasks for each historical work order of the historical work orders found in the search;
creating, by the one or more processors, tasks for resolving the one or more issues by optimizing one or more previously performed tasks of the plurality of previously performed tasks;
identifying, by the one or more processors, a plurality of technicians for resolving the one or more issues by identifying a plurality of previous technicians who performed tasks for each of the historical work orders, a performance rating of each previous technician of the plurality of previous technicians with regard to each of the historical work orders, and a plurality of factors;
generating, by the one or more processors based on the created tasks and the identified plurality of technicians, the work order for resolving the one or more issues;
executing, by the one or more processors, the work order to determine a subset of the plurality of technicians for resolving the one or more issues; and
presenting, by the one or more processors, the subset of the plurality of technicians as available technicians to resolve the one or more issues.

2. The computer-implemented method of claim 1, wherein the plurality of factors includes traffic conditions, weather conditions, cost of travel, estimated time when a technician from the plurality of technician can become available for resolving the one or more issues.

3. The computer-implemented method of claim 1, wherein determining the subset of the plurality of technicians comprises determining the subset of the plurality of technicians using a set of agents from a plurality of agents, wherein at least one agent from the set of agents is trained to identify a technician based on one or more of: a current location or geographical area of the technician, working hours of the technician, an acceptance trend, a cancellation trend, a no-show trend, honoring acceptance trend, a list of current work orders, availability of the technician, past history of the technician identifying any serious or sensitive issues, and/or an upcoming holiday.

4. The computer-implemented method of claim 3, further comprising creating, by the one or more processors, a Reinforcement Learning (RL) model for assigning rewards to the plurality of agents.

5. The computer-implemented method of claim 3, wherein determining the subset of the plurality of technicians further comprises:
generating, by the one or more processors, a work order confirmation prediction score for each technician of the subset of the plurality of technicians.

6. The computer-implemented method of claim 3, wherein the plurality of agents include Small Language Model (SLM) based agents, wherein the plurality of agents are managed by an agent orchestrator.

7. The computer-implemented method of claim 1, further comprising ranking, by the one or more processors, each technician of the subset of the plurality of technicians based on each technician's fitness to resolve the one or more issues according to criteria suggested by the potential user.

8. A system for managing a work order, the system comprising:
at least one memory configured to store machine-executable instructions; and
at least one processor communicatively coupled with the at least one memory, and configured to execute the machine-executable instructions to perform operations comprising:
receiving conversation history of a conversation originated by a potential user;
identifying from the conversation history, a plurality of key terms, wherein the plurality of key terms identify one or more issues to be resolved;
performing a search in a knowledge base storing historical work orders that are associated with the one or more issues to be resolved;
identifying a plurality of previously performed tasks for each historical work order of the historical work orders found in the search;
creating tasks for resolving the one or more issues by optimizing one or more previously performed tasks of the plurality of previously performed tasks;
identifying a plurality of technicians for resolving the one or more issues by identifying a plurality of previous technicians who performed tasks for each of the historical work orders, a performance rating of each previous technician of the plurality of previous technicians with regard to each of the historical work orders, and a plurality of factors;
generating, based on the created tasks and the identified plurality of technicians, the work order for resolving the one or more issues;
executing the work order to determine a subset of the plurality of technicians for resolving the one or more issues; and
presenting the subset of the plurality of technicians as available technicians to resolve the one or more issues.

9. The system of claim 8, wherein the plurality of factors includes traffic conditions, weather conditions, cost of travel, estimated time when a technician from the plurality of technician can become available for resolving the one or more issues.

10. The system of claim 8, wherein determining the subset of the plurality of technicians comprises determining the subset of the plurality of technicians using a set of agents from a plurality of agents, wherein at least one agent from the set of agents is trained to identify a technician based on one or more of: a current location or geographical area of the technician, working hours of the technician, an acceptance trend, a cancellation trend, a no-show trend, honoring acceptance trend, a list of current work orders, availability of the technician, past history of the technician identifying any serious or sensitive issues, and/or an upcoming holiday.

11. The system of claim 10, wherein the operations further comprise creating a Reinforcement Learning (RL) model for assigning rewards to the plurality of agents.

12. The system of claim 10, wherein determining the subset of the plurality of technicians further comprises:
generating a work order confirmation prediction score for each technician of the subset of the plurality of technicians.

13. The system of claim 10, wherein the plurality of agents include Small Language Model (SLM) based agents, wherein the plurality of agents are managed by an agent orchestrator.

14. The system of claim 8, wherein the operations further comprise ranking each technician of the subset of the plurality of technicians based on each technician's fitness to resolve the one or more issues according to criteria suggested by the potential user.

15. At least one non-transitory computer-readable medium (CRM) comprising machine-executable instructions, which, when executed by at least one processor of a system for managing a work order, cause the system to perform operations comprising:
receiving conversation history of a conversation originated by a potential user;
identifying from the conversation history, a plurality of key terms, wherein the plurality of key terms identify one or more issues to be resolved;
performing a search in a knowledge base storing historical work orders that are associated with the one or more issues to be resolved;
identifying a plurality of previously performed tasks for each historical work order of the historical work orders found in the search;
creating tasks for resolving the one or more issues by optimizing one or more previously performed tasks of the plurality of previously performed tasks;
identifying a plurality of technicians for resolving the one or more issues by identifying a plurality of previous technicians who performed tasks for each of the historical work orders, a performance rating of each previous technician of the plurality of previous technicians with regard to each of the historical work orders, and a plurality of factors;
generating, based on the created tasks and the identified plurality of technicians, the work order for resolving the one or more issues;
executing the work order to determine a subset of the plurality of technicians for resolving the one or more issues; and
presenting the subset of the plurality of technicians as available technicians to resolve the one or more issues.

16. The at least one non-transitory CRM of claim 15, wherein the plurality of factors includes traffic conditions, weather conditions, cost of travel, estimated time when a technician from the plurality of technician can become available for resolving the one or more issues.

17. The at least one non-transitory CRM of claim 15, wherein determining the subset of the plurality of technicians comprises determining the subset of the plurality of technicians using a set of agents from a plurality of agents, wherein at least one agent from the set of agents is trained to identify a technician based on one or more of: a current location or geographical area of the technician, working hours of the technician, an acceptance trend, a cancellation trend, a no-show trend, honoring acceptance trend, a list of current work orders, availability of the technician, past history of the technician identifying any serious or sensitive issues, and/or an upcoming holiday.

18. The at least one non-transitory CRM of claim 17, wherein determining the subset of the plurality of technicians further comprises:
generating a work order confirmation prediction score for each technician of the subset of the plurality of technicians.

19. The at least one non-transitory CRM of claim 17, wherein the plurality of agents include Small Language Model (SLM) based agents, wherein the plurality of agents are managed by an agent orchestrator.

20. The at least one non-transitory CRM of claim 15, wherein the operations further comprise ranking each technician of the subset of the plurality of technicians based on each technician's fitness to resolve the one or more issues according to criteria suggested by the potential user.
